(19) United States
(12) Patent Application Publication
(10) Pub. No.: US 2010/0212760 A1
(43) Pub. Date: Aug. 26, 2010

(54) WATER CONTROL VALVE CARTRIDGE

(76) Inventor: Jong Koo Kim, Incheon (KR)

Correspondence Address: HYUN JONG PARK;Park & Associates IP Law LLC, 265 Bic Drive, Suite 106, Milford, CT, 06461, US

(21) Appl. No.: 12/279,974

(22) PCT Filed: Feb. 26, 2007
(86) PCT No.: PCT/KR2007/000972

§ 371 Date: Aug. 19, 2008

(30) Foreign Application Priority Data
Mar. 22, 2006 (KR) 10-2006-0026217

(51) Int. Cl. F16K 11/02

(52) U.S. Cl. 137/605

(57) ABSTRACT

The present invention relates to a water control valve cartridge, which includes a single control knob that is capable of controlling the flow rate and the temperature of water, the control knob being manipulated within a predetermined planar area and controlling the flow rate or the temperature of water exclusively, or controlling the flow rate and temperature of the water at the same time, the control knob also reducing the number of elements of the cartridge and simplifying the combined construction of the cartridge, and improving the construction for manipulation of the control lever. The water control valve cartridge includes a water inlet and discharge unit for supplying and discharging water into and from the valve cartridge, the water inlet and discharge unit comprising cold and hot water inlet holes respectively connected to cold and hot water pipes, and a water discharge hole; an opening ratio control unit for controlling opening ratios of the cold and hot water inlet holes of the water inlet and discharge unit; a control lever for controlling forward, backward, leftward and rightward movement of the opening ratio control unit through a joystick motion; a valve control unit comprising a control knob that moves in a plane and actuates the control lever; and a housing for restricting the forward, backward, left-ward and rightward movement of the opening ratio control unit while supporting the control lever that executes the joystick motion. In the operation of the water control valve cartridge, the control knob is manipulated forwards or backwards to control the flow rate of the water, and is manipulated leftwards and rightwards to control the temperature of the water. Thus, the motion of the control knob when controlling the flow rate of the water does not interfere with the motion of the control knob when controlling the temperature of the water. Therefore, the present invention prevents a change in the temperature of the water when the flow rate of the water is controlled, and prevents a change in the flow rate of water when the temperature of the water is controlled. Further, the control knob can be finely manipulated, thus preventing undesired consumption of an excessive quantity of water and easily maintaining the water at a desired temperature.

### TECHNICAL FIELD

The present invention relates, in general, to water control valve cartridges and, more particularly, to a water control valve cartridge which can supply hot water or cold water exclusively, or can supply a mix of the hot water and cold water.

### BACKGROUND ART

Generally, a water control valve for controlling the temperature and flow rate of water has been configured to control the flow rate of water (including hot water supplied from a boiler), and to control the temperature of water by selecting cold water or hot water, or by mixing cold water and hot water. The water control valve capable of controlling the temperature and flow rate of water may be installed in a kitchen at an appropriate position above a sink or in a bathroom at a predetermined position above a bathtub, for example. It is thus convenient for a user in the kitchen or the bathroom to use water by manipulating the water control valve. Conventional water control valves capable of controlling the temperature and flow rate of water have been classified into knob-operated valves and lever-operated valves. The knob-operated water control valves are configured to control the flow rate and temperature of water using respective knobs which are designated for cold water and hot water and are manipulated by a user to control the flow rate of water as well as the temperature of water. The lever-operated water control valves are configured to control the flow rate of water by moving a lever upwards or downwards, and to control the temperature of water by appropriately rotating the lever leftwards or rightwards to select cold water, hot water, or a mix of the cold water and hot water together. In the conventional knob-operated water control valves, a cold water knob and a hot water knob are provided on opposite sides of a valve body. The cold water knob is manipulated to discharge cold water at a controlled flow rate, while the hot water knob is manipulated to discharge hot water at a controlled flow rate. Thus, when it is desired to use cold water or hot water exclusively, a user can easily control the flow rate of water by manipulating the knob designated for cold water or hot water. However, when it is desired to use mixed water of a desired temperature, the cold water knob and the hot water knob must both be carefully manipulated to provide the desired temperature, thus being inconvenient for users. Furthermore, each of the conventional knob-operated water control valves has a plurality of valve cartridges, which are used for separately controlling the flow rates of cold water and hot water and comprise many elements, so that the valve cartridges complicate the construction of the water control valves.

In an effort to overcome the above-mentioned problems, a water control valve, which is configured to control the flow rate and temperature of water at one side of the water control valve, has been proposed. However, the water control valve entails a manipulation problem in which the valve may change the current temperature of water during a flow rate control operation, and may change the existing flow rate of water during a temperature control operation. Thus, the use of the water control valve may result in excessive consumption of water. Further, the valve undesirably operates a boiler to heat water, thus consuming energy.

In order to solve the problems, the inventor of the present invention proposed a water control valve cartridge in Korean Patent Application No. 2005-0082784, which was filed on Sep. 6, 2005. The water control valve cartridge overcomes the problem experienced in the related art. However, the lever manipulation of the valve cartridge is executed through respective manipulation of a temperature control knob and a flow rate control knob, thus being difficult to manipulate. Another problem with the water control valve cartridge resides in that it has many elements, thus complicating the construction of the valve.

### DISCLOSURE OF INVENTION

### Technical Problem

Accordingly, the present invention has been made keeping in mind the above problems occurring in the related art, and an object of the present invention is to provide a water control valve cartridge, which comprises a single control knob that is capable of controlling the flow rate and the temperature of water, the control knob being manipulated within a predetermined planar area and controlling the flow rate or the temperature of water exclusively, or controlling the flow rate and temperature of the water at the same time, the control knob also reducing the number of elements of the cartridge and simplifying the combined construction of the cartridge, and improving the construction for manipulation of the control lever.

### Technical Solution

In order to accomplish the above object, the present invention provides a water control valve cartridge 10, which supplies hot water or cold water exclusively, or supplies a mix of the hot water and cold water, and comprises, as shown in FIGS. 1 through 4, a water inlet and discharge unit 1 for supplying and discharging water into and from the valve cartridge, the water inlet and discharge unit 1 comprising cold and hot water inlet holes 1a and 1b respectively connected to cold and hot water pipes, and a water discharge hole 1c; an opening ratio control unit 15 for controlling opening ratios of the cold and hot water inlet holes 1a and 1b of the water inlet and discharge unit 1; a control lever 14 for controlling forward, backward, leftward and rightward movement of the opening ratio control unit 15 through a joystick motion; a valve control unit 11 comprising a control knob 12 moving in a plane and actuating the control lever 14; and a housing 2 for restricting the forward, backward, leftward and rightward movement of the opening ratio control unit 15 while supporting the control lever 14 executing the joystick motion.

### ADVANTAGEOUS EFFECTS

As described above, in the operation of the water control valve cartridge according to the present invention, the control knob is manipulated forwards or backwards to control the flow rate of the water and is manipulated leftwards and rightwards to control the temperature of the water. Thus, the motion of the control knob when controlling the flow rate of the water does not interfere with the motion of the control knob when controlling the temperature of the water. Therefore, the present invention prevents a change in the temperature of the water when controlling the flow rate of the water, and prevents a change in the flow rate of water when controlling the temperature of the water. Further, the control knob can be finely manipulated, thus preventing undesired consumption of an excessive quantity of water and easily maintaining the water at a desired temperature.

### BRIEF DESCRIPTION OF THE DRAWINGS

FIG. 1 is a perspective view illustrating the construction of a water control valve cartridge according to the present invention;

FIG. 2 and FIG. 3 are exploded perspective views illustrating the construction of the water control valve cartridge according to the present invention in detail;

FIG. 4 is a front view illustrating the construction of the water control valve cartridge according to the present invention;

FIG. 5 and FIG. 6 are a front sectional view and a plane sectional view illustrating the water control valve cartridge according to the present invention in a closed state;

FIG. 7 and FIG. 8 are a front sectional view and a plane sectional view illustrating the water control valve cartridge according to the present invention in a partially opened state;

FIG. 9 and FIG. 10 are a front sectional view and a plane sectional view illustrating the water control valve cartridge according to the present invention in a fully opened state;

FIG. 11 and FIG. 12 are a side sectional view and a plane sectional view illustrating cold and hot water inlet holes according to the present invention in a mutually opened state;

FIG. 13 and FIG. 14 are a side sectional view and a plane sectional view illustrating the cold and hot water inlet holes according to the present invention in a cold water inlet hole opened state; and

FIG. 15 and FIG. 16 are a side sectional view and a plane sectional view illustrating the cold and hot water inlet holes according to the present invention in a hot water inlet hole opened state.

### BEST MODE FOR CARRYING OUT THE INVENTION

Herein below, preferred embodiments of the present invention will be described in detail with reference to the accompanying drawings.

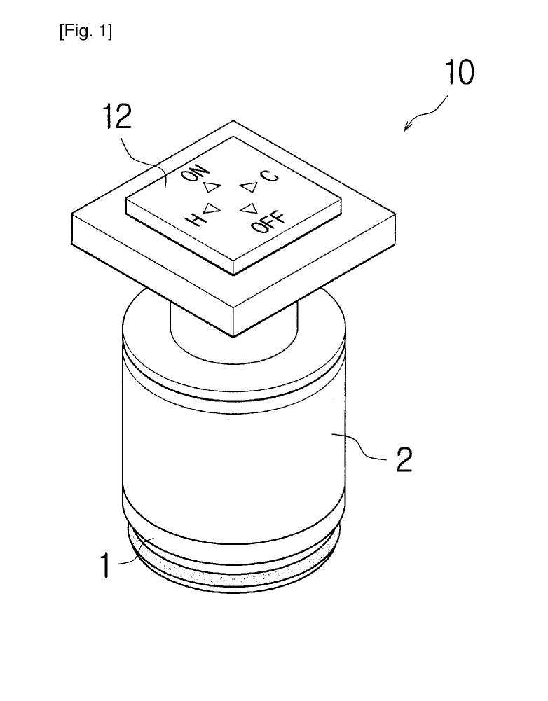

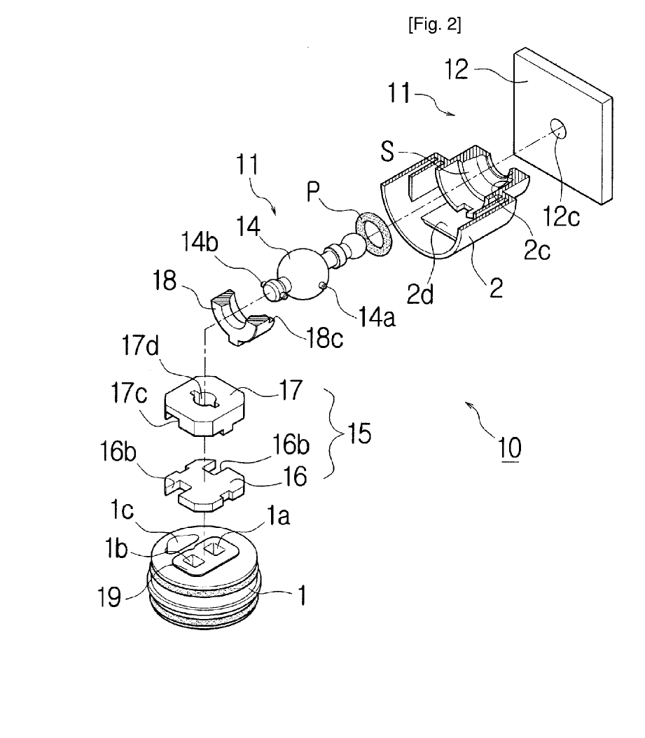

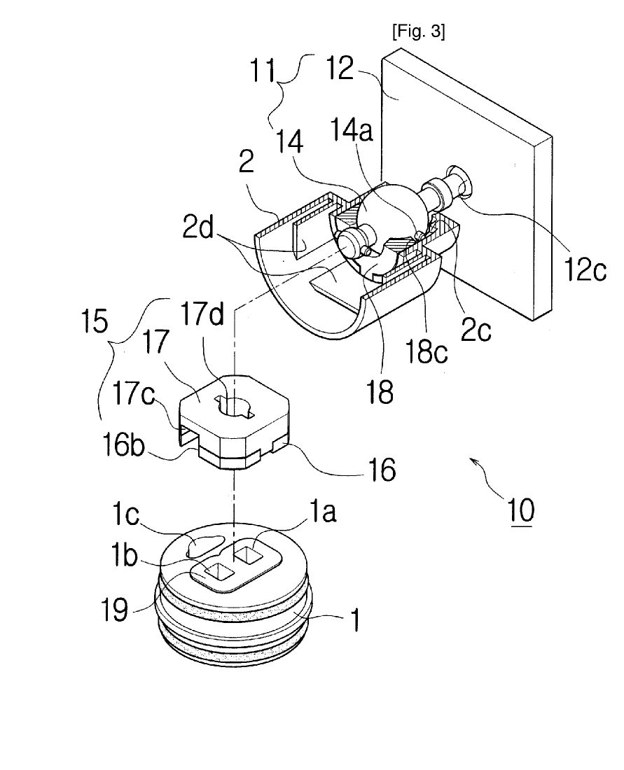

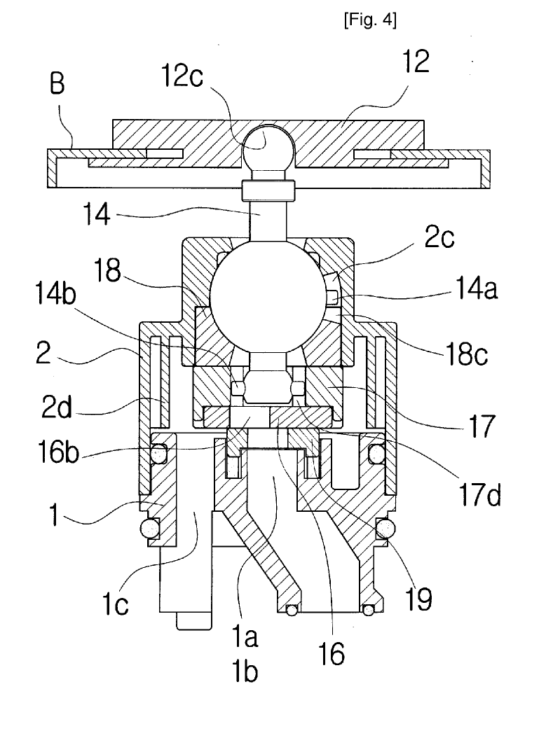

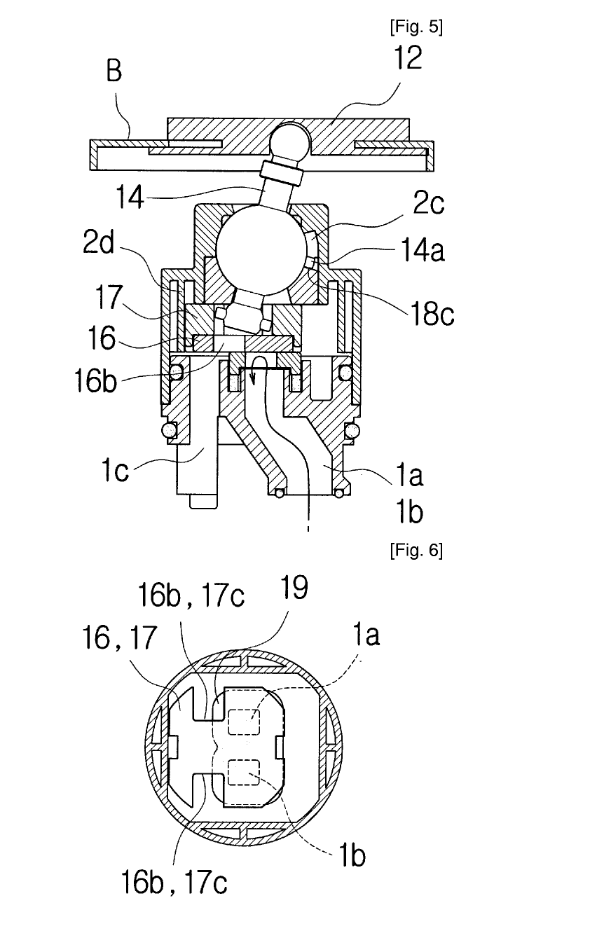

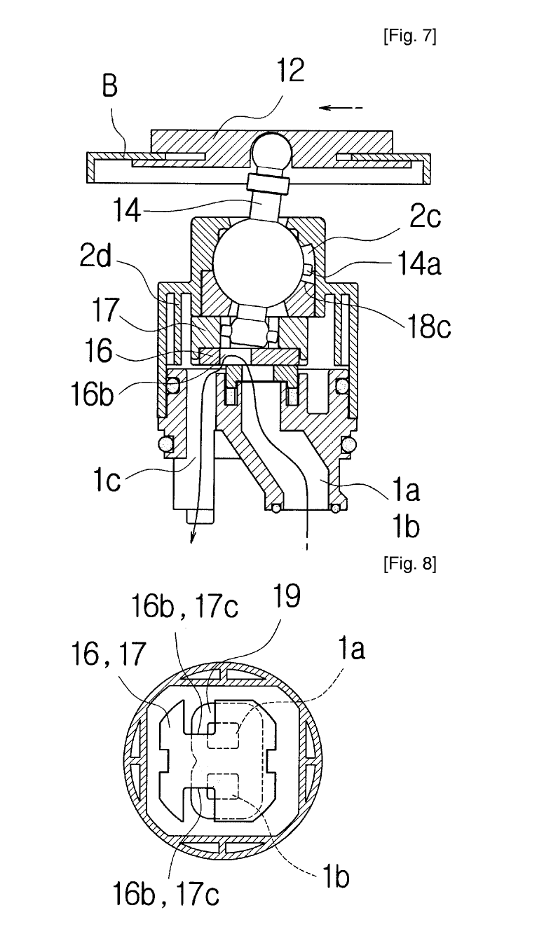

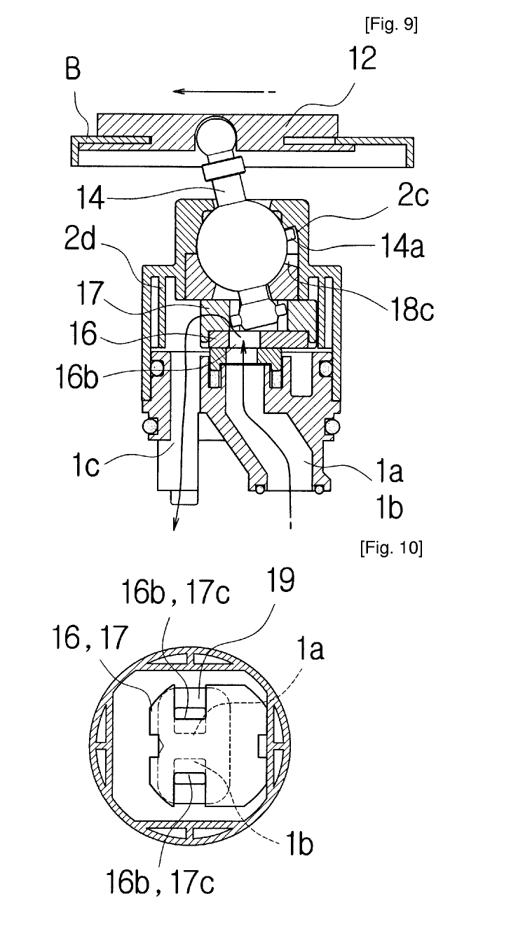

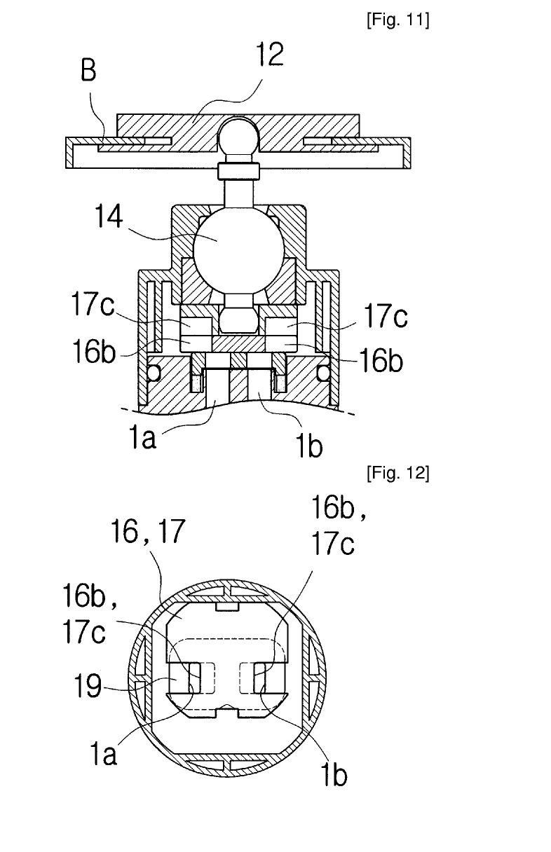

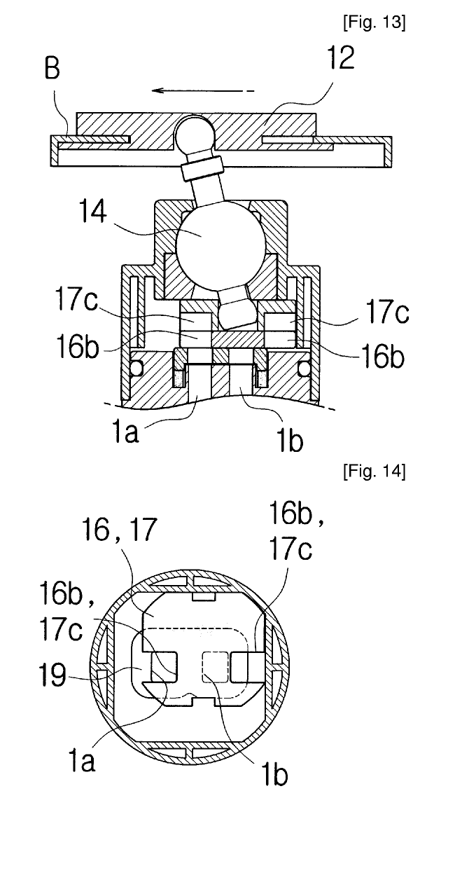

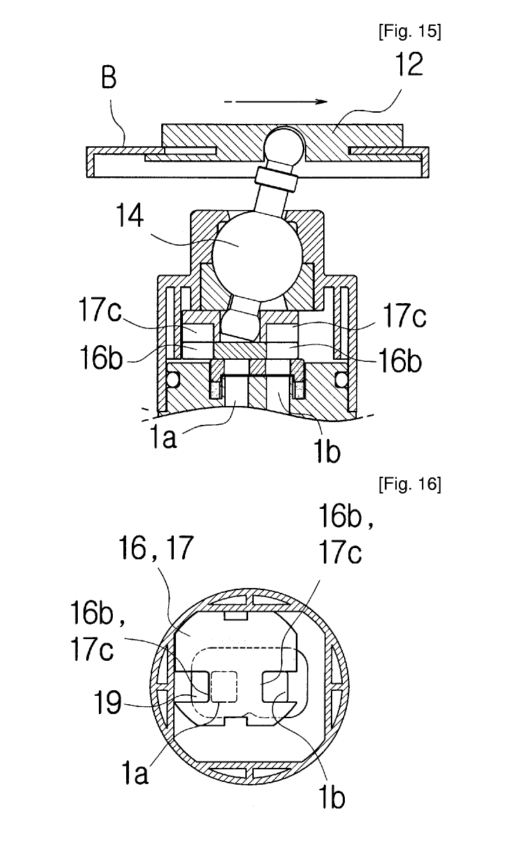

FIG. 1 is a perspective view illustrating the construction of a water control valve cartridge according to the present invention. FIG. 2 and FIG. 3 are exploded perspective views illustrating the construction of the water control valve cartridge in detail. FIG. 4 is a front view illustrating the construction of the water control valve cartridge. FIG. 5 and FIG. 6 are a front sectional view and a plane sectional view illustrating the water control valve cartridge in a closed state. FIG. 7 and FIG. 8 are a front sectional view and a plane sectional view illustrating the water control valve cartridge in a partially opened state. FIG. 9 and FIG. 10 are a front sectional view and a plane sectional view illustrating the water control valve cartridge in a fully opened state. FIG. 11 and FIG. 12 are a side sectional view and a plane sectional view illustrating cold and hot water inlet holes in a mutually opened state. FIG. 13 and FIG. 14 are a side sectional view and a plane sectional view illustrating the cold and hot water inlet holes in a cold water inlet hole opened state. FIG. 15 and FIG. 16 are a side sectional view and a plane sectional view illustrating the cold and hot water inlet holes in a hot water inlet hole opened state.

The water inlet and discharge unit 1 of the water control valve cartridge according to the present invention is configured as a block having a predetermined thickness. Cold and hot water inlet holes 1a and 1b are symmetrically formed through the central area of the block, while a water discharge hole 1c may be formed through part of the remaining portion of the block or through the entire remaining portion. In the above state, to achieve water-tightness between the cold and hot water inlet holes 1a and 1b and an opening ratio control unit 15 (a control disc 16), a close contact member 19, which is a ceramic disc and has a predetermined flatness and a predetermined surface roughness, is inserted between the cold and hot water inlet holes 1a and 1b and an opening ratio control unit 15. A packing for increasing water-tightness is further layered on the lower surface of the close contact member 19. Further, at least one packing is placed outside the side surface of the block so that it comes into contact with the inner surface of a housing, thus maintaining desired water-tightness of the valve cartridge. Each of the cold and hot water inlet holes 1a and 1b preferably has a rectangular profile which can evenly change the opening ratios of the cold and hot water inlet holes 1a and 1b.

The opening ratio control unit 15 of the present invention comprises a control disc 16 for opening or closing the cold and hot water inlet holes 1a and 1b of the water inlet and discharge unit 1; and a movable disc 17 for transmitting manipulation force, applied to the control lever 14, to the control disc 16. The control disc 16 is a plate-shaped ceramic disc. A first discharge guide channel 16b is formed in an inward direction at each side of the control disc 16 so as to correspond to the cold and hot water inlet holes 1a and 1b of the water inlet and discharge unit 1. Further, the movable disc 17 has a plate shape and is layered on the surface of the control disc 16. In the above state, second discharge guide channels 17c are formed on the movable disc 17 at locations corresponding to the first discharge guide channels 16b of the control disc 16. An insert slot 17d is formed in the movable disc 17 so as to receive an end of the control lever 14. The insert slot 17d has a structure which prevents rotation of the end of the control lever 14 relative to the movable disc 17. For example, a pin may be provided on the end of the control lever 14, while an insert groove may be formed in the insert slot 17d so as to receive the pin, thus preventing rotation of the end of the control lever 14 relative to the movable disc 17 through pin engagement. Alternatively, the end of the control lever 14 may be formed into a rectangular shape, and a rectangular slot may be formed through the movable disc 17 so as to engage with the rectangular end, thus preventing rotation of the end of the control lever 14 relative to the movable disc 17. Further, the control disc 16 and the movable disc 17 may have locking slots and locking protrusions, respectively, thereby engaging with each other. For example, locking slots may be formed in the control disc 16 at locations angularly spaced apart from the first discharge guide channels 16b, while locking protrusions may be formed in the movable disc 17 at locations angularly spaced apart from the second discharge guide channels 17c, so as to engage with the locking slots.

The control lever 14 of the valve control unit 11 of the present invention is a stick, which is inserted at the first end thereof into the slot 17d of the movable disc 17. The middle of the stick is shaped as a ball which is received in the housing 2, while the second end of the stick is inserted into the control knob 12.

A guide protrusion 14a is formed on the center of the surface of the control lever 14 and ensures rectilinear movement of the control disc 16 when controlling the flow rate of water. Further, as described above, the first end of the control lever 14, which is inserted into and engages with the movable disc 17, may be provided with pins 14b or may be shaped as a rectangular end so as to prevent rotation of the control lever 14 relative to the movable disc 17. In the above state, it is possible to prevent undesired movement of the movable disc 17 and the control disc 16 during manipulation of the control lever 14. Further, the control knob 12 is a plate-shaped body, which has a slot 12c at a center thereof to receive the second end of the control lever 14. In the above state, the control knob 12 is seated on a separate support board B and moves on the support board B forwards, backwards, leftwards and rightwards in horizontal directions.

To prevent the control knob 12 from being undesirably removed from the support board B, the control knob 12 may be engaged with the support board B using prominences and depressions or the outside surface of the control knob 12 may be stepped to engage with the support board B. Further, the control knob 12 may have a rectangular shape, as shown in the drawings. Alternatively, the control knob 12 may have a hemispherical shape, a spherical shape, or some other polygonal shape.

The housing 2 of the present invention is a pipe having a double cap shape, with a space S defined inside the end having a smaller diameter to receive the middle portion of the control lever 14. A control lever support 18 is inserted into the end of the housing 2 having the smaller diameter, which faces the control disc 16, so that the control lever support 18 holds the middle portion of the control lever 14 in the housing 2 while supporting the control lever 14. In the above state, first and second guide channels 2c and 18c are formed on the housing 2 and the control lever support 18, respectively, so as to communicate with each other, thus forming a moving passage for the guide protrusion 14a of the control lever 14. Further, four stoppers 2d may be provided on the inner surface of the housing 2 at four angularly spaced positions so as to restrict movement of the control disc 16 in the housing 2. Alternatively, the inner space of the housing 2 may have a rectangular shape so as to restrict the movement of the control disc 16 in the housing 2. Further, a packing P is provided in the housing 2, which receives the middle portion of the control lever 14, thus maintaining desired water-tightness.

The water control valve cartridge having the above-mentioned construction according to the present invention will be operated as follows.

As shown in FIG. 5, the control knob 12 of the present invention is placed at a predetermined location (to the right in the drawings). In the above state, the control lever 14 pushes the control disc 16 of the opening ratio control unit 15 toward the water inlet and discharge unit 1 and housing 2, so that the flat surface of the control disc 16 fully closes the cold and hot water inlet holes 1a and 1b of the water inlet and discharge unit 1.

Thus, the control disc 16 prevents cold water and hot water from the cold and hot water pipes from flowing into the valve cartridge 10, as shown in FIG. 6.

However, in the above state, as shown in FIG. 7, when the control knob 12 is pushed toward the front of the housing 2, the control disc 16 is pulled backwards around the middle portion of the control lever 14, which acts as a central shaft in the gap between the space S of the housing 2 and the control lever support 18. (In the above state, the guide protrusion 14a of the control lever 14 moves along the second guide channel 18c of the control lever support 18, thus being guided to the first guide channel 2c of the housing 2. This guidance of the guide protrusion 14a induces desired rectilinear movement of the control disc 16.) Thus, the first and second discharge guide channels 16b and 17c of the control disc 16 and the movable disc 17 move toward the cold and hot water inlet holes 1a and 1b of the water inlet and discharge unit 1. In the above state, the cold and hot water inlet holes 1a and 1b of the water inlet and discharge unit 1 communicate with the water discharge hole 1c, so that water introduced into the valve cartridge through the cold and hot water inlet holes 1a and 1b can be discharged outside through the water discharge hole 1c, as shown in FIG. 8.

In the above state, when the control knob 12 is fully pushed toward the front of the housing 2, as shown in FIG. 9, the first and second discharge guide channels 16b and 17c of the control disc 16 and the movable disc 17 fully communicate with the cold and hot water inlet holes 1a and 1b of the water inlet and discharge unit 1. Thus, the flow rate of water flowing through the cold and hot water inlet holes 1a and 1b of the water inlet and discharge unit 1 increases to the maximum, and the water is discharged outside through the water discharge hole 1c, as shown in FIG. 10. In the drawing, the first and second discharge guide channels 16b and 17c partially overlap the cold and hot water inlet holes 1a and 1b. However, it should be understood that the overlapping areas of the first and second discharge guide channels 16b and 17c relative to the cold and hot water inlet holes 1a and 1b may be changed as desired.

Thus, the present invention can control the flow rate of water as well as opening or closing the water control valve.

Further, when the control knob 12 is manipulated to be located at a neutral position, as shown in FIG. 11, under the state in which the flow rate of water has been controlled to be at the maximum or minimum, as described above, the opening ratios of the first and second discharge guide channels 16b and 17c of the control disc 16 and the movable disc 17 relative to the cold and hot water inlet holes 1a and 1b become equal to each other, as shown in FIG. 12. Thus, the flow rates of cold water and hot water, which are supplied from the outside, become equal to each other, and water having a desired temperature can be discharged to the outside through the water discharge hole 1c.

However, in the above state, as shown in FIG. 13, when the control knob 12 is pushed to one side of the housing 2(leftwards in the drawing), the first and second discharge guide channels 16b and 17c are moved toward the cold water inlet hole 1a of the cold and hot water inlet holes 1a and 1b of the water inlet and discharge unit 1.

Thus, the cold water inlet hole 1a of the water inlet and discharge unit 1 communicates with the water discharge hole 1c, so that water which has been introduced into the valve cartridge through the cold water inlet hole 1a is discharged to the outside through the water discharge hole 1c, as shown in FIG. 14.

In the above state, when the control knob 12 is pushed to the other side of the housing 2 (rightwards in the drawing), as shown in FIG. 15, the first and second discharge guide channels 16b and 17c communicate with the hot water inlet hole 1b of the water inlet and discharge unit 1. Thus, water which has been introduced into the valve cartridge through the hot water inlet hole 1b of the water inlet and discharge unit 1 is discharged to the outside through the water discharge hole 1c.

Of course, the closed areas of the cold and hot water inlet holes 1a and 1b relative to the first and second discharge guide channels 16b and 17c can be controlled by leftward and rightward movement of the control knob 12.

As described above, the present invention is configured such that the control knob 12 can be manipulated forwards, backwards, leftwards and rightwards in a plane, so that the valve cartridge of the present invention can be finely and easily manipulated, and so that the number of elements of the cartridge is reduced, thus simplifying the combined construction of the cartridge.

In the drawings and specification, typical preferred embodiments of the invention have been disclosed and, although specific terms are employed, they are used in a generic and descriptive sense only and not for purposes of limitation, the scope of the invention being set forth in the following claims.

### INDUSTRIAL APPLICABILITY

As described above, in the operation of the water control valve cartridge according to the present invention, the control knob is manipulated forwards or backwards to control the flow rate of the water, and is manipulated leftwards and rightwards to control the temperature of the water. Thus, the motion of the control knob when controlling the flow rate of the water does not interfere with the motion of the control knob when controlling the temperature of the water. Therefore, the present invention prevents a change in the temperature of the water when the flow rate of the water is controlled, and prevents a change in the flow rate of water when the temperature of the water is controlled. Further, the control knob can be finely manipulated, thus preventing undesired consumption of an excessive quantity of water and easily maintaining the water at a desired temperature.

1. A water control valve cartridge, which supplies hot water or cold water exclusively, or supplies a mix of the hot water and cold water, and comprises:
a water inlet and discharge unit for supplying and discharging water into and from the valve cartridge, the water inlet and discharge unit comprising cold and hot water inlet holes respectively connected to cold and hot water pipes, and a water discharge hole;
an opening ratio control unit for controlling opening ratios of the cold and hot water inlet holes of the water inlet and discharge unit;
a control lever for controlling forward, backward, leftward and rightward movement of the opening ratio control unit through a joystick motion;
a valve control unit comprising a control knob moving in a plane and actuating the control lever; and
a housing for restricting the forward, backward, leftward and rightward movement of the opening ratio control unit while supporting the control lever executing the joystick motion.

2. The water control valve cartridge according to claim 1, wherein the water inlet and discharge unit is configured as a block having a predetermined thickness, with the cold and hot water inlet holes being symmetrically formed through a central area of the block and the water discharge hole being formed through part of a remaining portion of the block.

3. The water control valve cartridge according to claim 2, further comprising:
a close contact member made of ceramic having rectangular hole and inserted into the cold and hot water inlet holes.

4. The water control valve cartridge according to claim 1, wherein the opening ratio control unit comprises:
a control disc for opening or closing the cold and hot water inlet holes of the water inlet and discharge unit; and
a movable disc for transmitting manipulation force, applied to the control lever, to the control disc.

5. The water control valve cartridge according to claim 4, wherein the control disc is a plate-shaped ceramic disc, with a first discharge guide channel formed in an inward direction at each side of the control disc so as to correspond to the cold and hot water inlet holes of the water inlet and discharge unit.

6. The water control valve cartridge according to claim 4, wherein the movable disc has a plate shape and is layered on a surface of the control disc, with second discharge guide channels formed on the movable disc at locations corresponding to first discharge guide channels of the control disc, and an insert slot formed in the movable disc to receive an end of the control lever.

7. The water control valve cartridge according to claim 1, wherein the control lever is a stick, which is inserted at a first end thereof into a slot of a movable disc of the opening ratio control unit, and is shaped as a ball at a middle thereof so as to be received in the housing, and is inserted at a second end thereof into the control knob.

8. The water control valve cartridge according to claim 7, wherein the control lever is provided at a center of a surface thereof with a guide protrusion so as to ensure rectilinear movement of a control disc of the opening ratio control unit when controlling the flow rate of water.

9. The water control valve cartridge according to claim 7, wherein the end of the control lever, which engages with the movable disc through insertion, is provided with pins so as to prevent rotation of the control lever relative to the movable disc.

10. The water control valve cartridge according to claim 7, wherein the end of the control lever, which engages with the movable disc through insertion, is shaped as a rectangular end.

11. The water control valve cartridge according to claim 7, wherein the control knob is a plate-shaped body, with a slot formed in a center of the control knob to receive the second end of the control lever.

12. The water control valve cartridge according to claim 1, wherein the housing is a pipe having a double cap shape, with a space defined inside an end thereof having a smaller diameter to receive a middle portion of the control lever, a control lever support inserted into the end of the housing having the smaller diameter so as to face a control disc of the opening ratio control unit, thus holding the middle portion of the control lever in the housing while supporting the control lever.

13. The water control valve cartridge according to claim 12, further comprising:
first and second guide channels formed on the housing and the control lever support, respectively, so as to communicate with each other, thus forming a moving passage for a guide protrusion of the control lever.

14. The water control valve cartridge according to claim 12, further comprising:
four stoppers provided on an inner surface of the housing at four angularly spaced positions so as to restrict movement of the control disc in the housing.

15. The water control valve cartridge according to claim 12, wherein the housing has a rectangular inner space so as to restrict movement of the control disc in the housing.
